(19) United States
(12) Patent Application Publication
(10) Pub. No.: US 2025/0034907 A1
(43) Pub. Date: Jan. 30, 2025

(54) LATCH ASSEMBLY AND METHOD OF OPERATING THE SAME

(71) Applicant: ASSA ABLOY Americas Residential Inc., New Haven, CT (US)

(72) Inventor: Oscar Romero, Laguna Woods, CA (US)

(73) Assignee: ASSA ABLOY Americas Residential Inc., New Haven, CT (US)

(21) Appl. No.: 18/770,965

(22) Filed: Jul. 12, 2024

Related U.S. Application Data
(60) Provisional application No. 63/515,644, filed on Jul. 26, 2023.

(51) Int. Cl. E05B 63/20; E05B 15/10

(52) U.S. Cl. CPC E05B 63/20; E05B 15/102

(57) ABSTRACT

A latch assembly includes a housing, a bolt pivotably coupled to a first end of a carriage, and a locking bar. The bolt is configured to extend and retract relative to a first end of the housing. An interposer member is independently slidable along the longitudinal axis relative to the carriage. Upon sliding the interposer member towards a second end of the housing, the interposer member engages the locking bar and moves the locking bar out of an axial path of a second end of the carriage. The bolt being allowed to retract relative to the first end of the housing.

### CROSS-REFERENCE TO RELATED APPLICATION(S)

This application claims the benefit of priority to U.S. Provisional Application No. 63/515,644, filed Jul. 26, 2023, which application is hereby incorporated in its entirety by reference.

### BACKGROUND

This disclosure relates generally to latch assemblies and, more particularly, to a dead locking latch assembly having an interposer member.

At least some known latch assemblies are mounted at least partially inside a door and are configured so that a bolt may selectively extend from the door and into a strike plate on a door jamb to secure or lock the door. Retraction of the bolt allows the bolt to disengage the strike plate and the door to open. In some latch assemblies, the bolt may be actively pushed and pulled between its extended and retracted positions (e.g., via a door lever, handle, or knob), and when the door is closed, the bolt can automatically slide past the strike plate. Other latch assemblies include a bolt that can pivot and slide so that the door lever merely disengages the bolt and retraction movement occurs as the bolt slides past the strike plate when the door opens and closes. These latch assemblies may include an interior blocking system to prevent undesirable retraction of the bolt. Improvements to latch assemblies are desired so that pivoting and sliding bolts can more efficiently operate.

### SUMMARY

The present disclosure relates generally to latch assemblies that are configured to extend and retract a bolt based on contact with a strike plate on a door frame. The latch assembly includes an interposer member configured to engage with a locking bar assembly and enable the bolt to retract from an extended position as the latch assembly moves past the strike plate and while a door is being closed.

In an aspect, the technology relates to a latch assembly including: a housing having a first end and an opposite second end defining a longitudinal axis; at least one locking bar disposed proximate the second end of the housing, the at least one locking bar transversely moveable relative to the longitudinal axis; a bolt mounted at the first end of the housing, the bolt selectively moveable relative to the first end of the housing; a carriage disposed within the housing and slidable along the longitudinal axis, the carriage having a first end and an opposite second end, the bolt pivotably coupled to the first end of the carriage and the second end of the carriage disposed proximate the at least one locking bar; and an interposer member independently slidable along the longitudinal axis relative to the carriage, wherein upon sliding the interposer member towards the second end of the housing, the interposer member engages the at least one locking bar and moves the at least one locking bar out of an axial path of the second end of the carriage, thereby allowing the bolt to retract relative to the first end of the housing.

In an example, the interposer member is biased along the longitudinal axis such that at least a portion of the interposer member projects adjacent the bolt. In another example, the latch assembly further includes an axial biasing member, the axial biasing member directly engaged with the interposer member. In yet another example, the interposer member is disposed at least partially within the bolt. In still another example, the interposer member includes a nose and a tail, the nose having at least one oblique surface. In an example, the second end of the carriage defines at least one notch, at least a portion of the tail received within the at least one notch. In another example, the tail includes at least one curved surface.

In another aspect, the technology relates to a latch assembly including: a housing having a first end and an opposite second end defining a longitudinal axis; at least one locking bar disposed proximate the second end of the housing, the at least one locking bar transversely moveable relative to the longitudinal axis between at least a blocking position and an unblocked position; a bolt mounted at the first end of the housing, the bolt selectively moveable between at least an extended position and a retracted position relative to the first end of the housing; a carriage disposed within the housing and slidable along the longitudinal axis, the carriage having a first end and an opposite second end, the bolt pivotably coupled to the first end of the carriage, wherein when the at least one locking bar is in the blocking position, the at least one locking bar is positioned in an axial path of the second end of the carriage, thereby restricting the bolt from moving from the extended position towards the retracted position; and an interposer member movable between at least an engaged position and a disengaged position relative to the at least one locking bar along the longitudinal axis, wherein upon moving the interposer member towards the engaged position, the interposer member engages and moves the at least one locking bar towards the unblocked position, thereby removing the at least one locking bar from the axial path of the second end of the carriage and allowing the bolt to move towards the retracted position.

In an example, the latch assembly further includes an axial biasing member biasing the interposer member towards the disengaged position. In another example, the axial biasing member directly engages with the interposer member. In yet another example, the interposer member is at least partially disposed within the carriage. In still another example, the interposer member includes a nose and a tail extending along the longitudinal axis, the tail configured to engage with the at least one locking bar in the engaged position. In an example, the nose at least partially projects from the bolt when the bolt is in the extended position.

In another example, the bolt includes an oblique surface, the nose disposed at the oblique surface. In yet another example, the interposer member is independently slidable relative to both the carriage and the bolt. In still another example, the bolt is pivotable relative to the interposer member.

In another aspect, the technology relates to a method of operating a latch assembly installed on a door, the method including: providing a latch assembly installed on a door, the latch assembly including a housing having a first end and an opposite second end defining a longitudinal axis, at least one locking bar disposed proximate the second end of the housing, the at least one locking bar transversely moveable relative to the longitudinal axis, a bolt mounted at the first end of the housing, the bolt selectively moveable relative to the first end of the housing, a carriage disposed within the housing and slidable along the longitudinal axis, the carriage having a first end and an opposite second end, the bolt pivotably coupled to the first end of the carriage and the second end of the carriage is disposed proximate the at least one locking bar, and an interposer member independently slidable along the longitudinal axis relative to the carriage; from an open position, swinging the door towards a strike plate to close the door, wherein when the door is in the open position, the latch assembly is automatically biased so that the bolt and at least a portion of the interposer member extend from the first end of the housing; contacting the strike plate with the interposer member extending from the first end of the housing such that the interposer member slides towards the second end of the housing and engages the at least one locking bar to move the at least one locking bar out of an axial path of the second end of the carriage; and upon moving the at least one locking bar out of the axial path of the second of the carriage, retracting the bolt relative to the first end of the housing.

In an example, when the interposer member slides towards the second end of the housing via contact with the strike plate, the interposer member slides independently from the carriage and the bolt. In another example, the method further includes opening the door from a closed position, wherein the bolt contacts the strike plate and pivots relative to the interposer member causing the interposer member to slide along the longitudinal axis. In yet another example, when the door swings towards the strike plate, the interposer member contacts the strike plate prior to the bolt.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 is plan view of an exemplary latch assembly mounted within a door and in accordance with the principles of the present disclosure.

FIGS. 2 and 3 are perspective views of the latch assembly shown in FIG. 1.

FIG. 4 is an exploded, perspective view of the latch assembly shown in FIG. 1.

FIGS. 5 and 6 are perspective views of an extension assembly of the latch assembly shown in FIG. 1.

FIGS. 7 and 8 are longitudinal cross-sectional views of the latch assembly shown in FIG. 1.

FIG. 9 is another longitudinal cross-sectional view of the latch assembly shown in FIG. 1 and with a locking bar assembly in an unblocked position.

FIG. 10 is another longitudinal cross-sectional view of the latch assembly shown in FIG. 1 and with a bolt in a retracted position.

FIG. 11 is another longitudinal cross-sectional view of the latch assembly shown in FIG. 1 and with an interposer member in an engaged position.

FIG. 12 is another longitudinal cross-sectional view of the latch assembly shown in FIG. 1 and with the bolt in another retracted position.

FIG. 13 illustrates a flowchart depicting a method of operating a latch assembly installed on a door.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

Latch assemblies typically have a bolt and the bolt extends or retracts from a housing via actuation of a lever. Some known latch assemblies do not have actuation of a lever directly drive movement of the bolt; rather, the lever is used to unlatch the bolt so that as the door opens or closes and slides past a strike plate mounted on a door frame, the bolt is enabled so as to automatically retract upon contact. These bolts, however, also need to have structure that maintains the bolt in the extended position, unless the door is be opened or closed, so as to latch the door in a closed position and engaged with the strike plate.

The latch assembly described herein includes a bolt, a locking bar assembly, and an extension assembly. The extension assembly is configured to bias the bolt towards an extended position. The locking bar assembly blocks and unblocks the extension assembly so as to selectively enable the bolt to retract. For example, when the door is opening, the lever is used to unblock the locking bar assembly and allow the bolt to both pivot and slide to move towards a retracted position when passing across the strike plate. The door can then be enabled to be opened. Once opened, the bolt is biased to automatically extend and the locking bar moves back towards the blocking position. When the door is closing, the extension assembly includes an interposer member that contacts the strike plate first to engage the locking bar assembly and move it towards the unblocked position so that the bolt is allowed to retract when passing across the strike plate in an opposite direction and without operation of the lever.

The interposer member allows the bolt to be biased completely towards the extended position and there is no intermediate position that the bolt is configured to maintain. As such, the components of the latch assembly more efficiently operate the bolt and performance of the extension and retraction movement of the bolt increases.

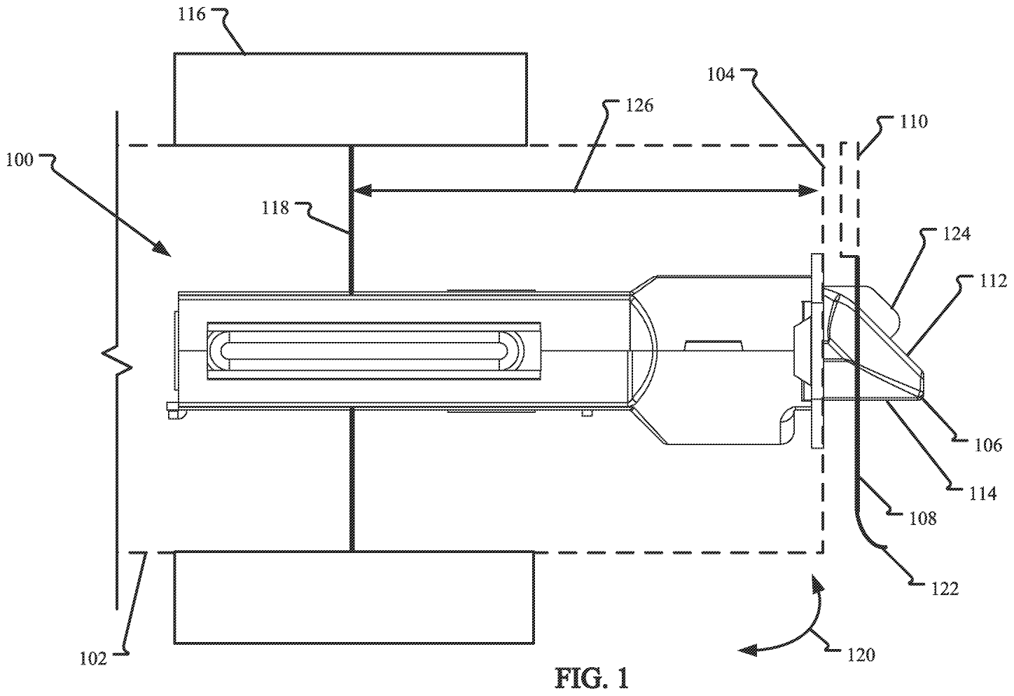

FIG. 1 is plan view of an exemplary latch assembly 100 mounted within a door 102. The latch assembly 100 is configured to be mounted at an edge 104 with a bolt 106 extending therefrom. The bolt 106 is configured to be selective movable between at least an extended position (as illustrated in FIG. 1) and a retracted position (not shown). When the door 102 is in a closed position (as illustrated in FIG. 1), the bolt 106 at least partially extends within and engages with a strike plate 108 (e.g., a keeper) mounted on a door jamb 110. The bolt 106 includes an oblique or curved surface 112 and a planar surface 114. The planar surface 114 restricts or prevents the door 102 from opening without first unlatching the bolt 106 so that it is allowed to move towards the retracted position. In the example, the bolt 106 may both pivot and slide to move between the extended position and retraced position once unlatched. In other examples, the bolt 106 may pivot or slide only to move between the extended position and retracted position when unlatched.

The latch assembly 100 can be coupled to a handle assembly 116 via a torque blade or drive shaft 118 so as to drive operation of the bolt 106. The handle assembly 116 may include handles on one or both sides of the door 102 that are configured to rotate the torque blade 118 and unlatch the bolt 106. Generally, the latch assembly 100 and the handle assembly 116 may be referred to as a lock assembly or lockset assembly. The term “lock” or “lockset” is broadly intended to include any type of lock, including, but not limited to, deadbolts, knob locks, lever handle locks, mortise locks, and slide locks, whether mechanical, electrical, or electro-mechanical locks. The locking points may have various mounting configurations and/or locations, including, but not limited to: mortised within the doorframe (as described herein), mounted externally to the doorframe or support structure, and/or affixed directly to the door.

Once the door 102 is opened and the door 102 is to be closed, the door 102 swings 120 towards the door jamb 110 and the oblique surface 112 of the bolt 106 contacts a lip 122 of the strike plate 108. The contact between the bolt 106 and the strike plate 108 automatically retracts the bolt 106 so that the door 102 can close, and the bolt 106 is biased so as to automatically extend once within the strike box of the strike plate 108. In the example, the latch assembly 100 also includes an interposer member 124 disposed proximate the oblique surface 112. In order to allow the bolt 106 to move towards the retracted position, the interposer member 124 is engaged so as to unlatch the bolt 106. The interposer member 124 is configured to engage with the lip 122 of the strike plate 108 so as to automatically unlatch the bolt 106 when the door 102 swings closed. The interposer member 124 facilitates a more efficient latching and unlatching operation for the bolt 106 as described herein, and thereby, increasing performance of the latch assembly 100.

Additionally, the latch assembly 100 has a variable backset distance 126 and so that the latch assembly 100 is operable for at least two different backset distances. The variable backset distance 126 does not require any modification or adjustment to the components of the latch assembly 100. The backset distance 126 can be measured from the edge 104 of the door 102 and a center line of the torque blade 118.

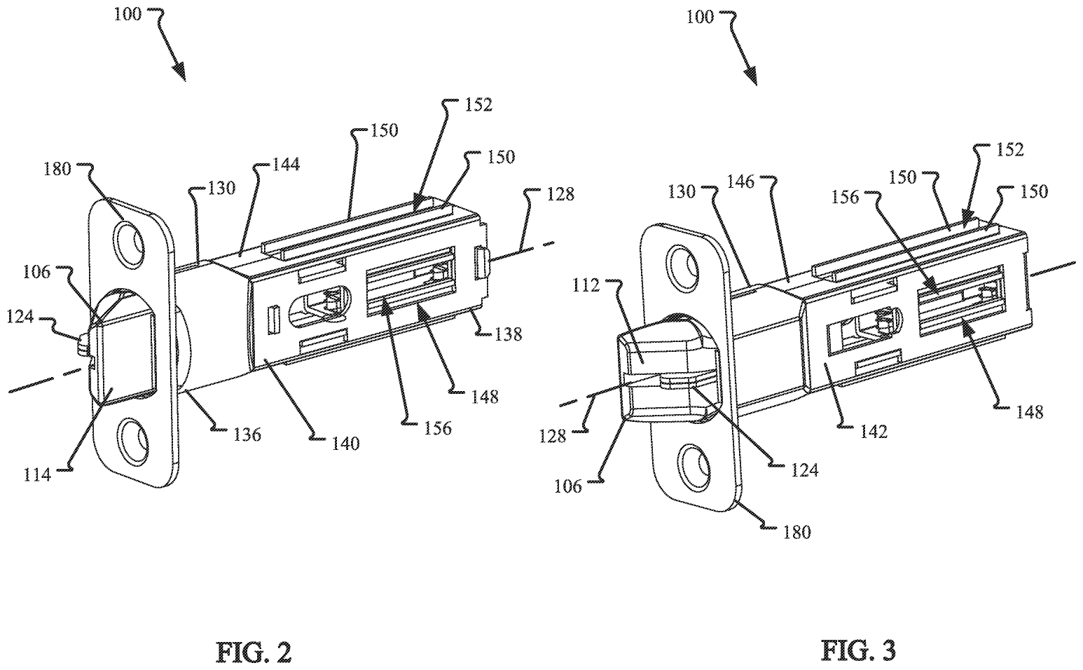

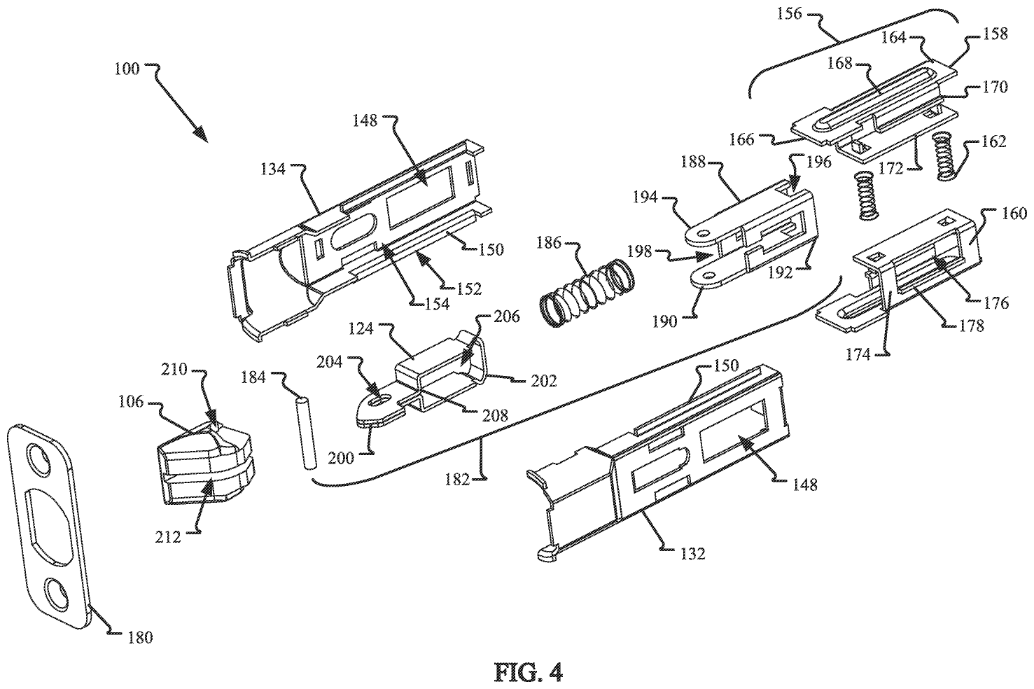

FIGS. 2 and 3 are perspective views of the latch assembly 100, FIGS. 2 and 3 show opposite sides of the latch assembly 100 and with the latch assembly 100 rotated 180° about a longitudinal axis 128. FIG. 4 is an exploded, perspective view of the latch assembly 100. Referring concurrently to FIGS. 2-4, the latch assembly 100 includes a housing 130 that may have a first body 132 and a second body 134. The housing 130 has a first end 136 and a second end 138 that extend along the longitudinal axis 128. The housing 130 has a first vertical sidewall 140 defined by the first body 132 and an opposite second vertical sidewall 142 defined by the second body 134. A first horizontal sidewall 144 and an opposite second horizontal sidewall 146 are defined by portions of both the first body 132 and the second body 134. The first and second horizontal sidewalls 144, 146 and the first and second vertical sidewalls 140, 142 are substantially parallel with the longitudinal axis 128.

The first and second vertical sidewalls 140, 142 each have an opening 148 disposed proximate the second end 138 of the housing 130. The opening 148 is elongated along the longitudinal axis 128 and is configured so that the torque blade 118 (shown in FIG. 1) can extend within the housing 130. The first and second horizontal sidewalls 144, 146 each have a flange 150 projecting outwards and forming a notch 152 that extends along the longitudinal axis 128.

The housing 130 defines an interior cavity 154 that houses at least a portion of a locking bar assembly 156 disposed at the second end 138 of the housing 130. The locking bar assembly 156 includes a first locking bar 158, a second locking bar 160, and at least one biasing member 162. Each locking bar 158, 160 has the same geometry and includes a bar base 164 with an extension arm 166 projecting towards the first end 136 of the housing 130, a lug 168 configured to be at least partially received within the notch 152 of the horizontal sidewalls 144, 146, and an engagement tab 170 extending from the bar base 164 that is configured to be at least partially received within the opening 148 of the vertical sidewalls 140, 142. Parallel to the bar base 164, each locking bar 158, 160 includes a connector arm 172 that is connected to the bar base 164 with a wall 174 having an opening 176 with a flange 178. The locking bar assembly 156 is further described in U.S. Pat. No. 11,220,839 and which is incorporated by reference herein in its entirety.

The first end 136 of the housing 130 is configured to couple to a face plate 180 that is configured to mount to the edge 104 of the door 102 (both shown in FIG. 1). The bolt 106 is both slidably and pivotably mounted at least partially within the housing 130 at the first end 136 via an extension assembly 182 disposed at least partially within the housing 130 and selectively slidably along the longitudinal axis 128. The extension assembly 182 includes a pivot pin 184, the interposer member 124, a biasing member 186, and a carriage 188. The carriage 188 includes a first end 190 and an opposite second end 192 that extends along the longitudinal axis 128. The first end 190 includes a pair of arms 194 that receives the pivot pin 184 so as to pivotably couple the bolt 106 to the carriage 188. The second end 192 includes a pair of notches 196 axially aligned with the arms 194. The carriage 188 forms an inner cavity 198 that at least partially receives the biasing member 186 and the interposer member 124.

The interposer member 124 includes a nose 200 and an opposite tail 202 extending along the longitudinal axis 128. The nose 200 includes an elongated slot 204 that receives the pivot pin 184 and allows the interposer member 124 to at least partially slide relative to the bolt 106. The tail 202 forms an inner cavity 206 that receives the biasing member 186. The interposer member 124 forms a transverse wall 208 that forms a stop and that directly abuts the biasing member 186.

The bolt 106 includes a transverse hole 210 that receives the pivot pin 184 and an axial slot 212 that receives the nose 200 of the interposer member 124. As such, the bolt 106 is pivotable and slidable with respect to the interposer member 124.

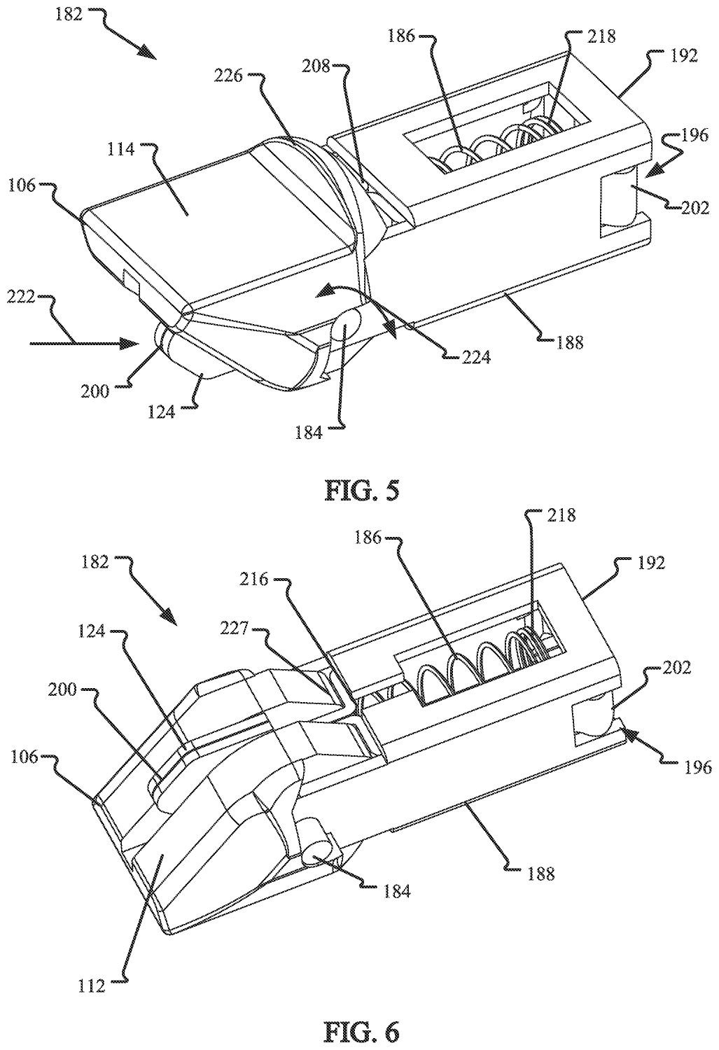

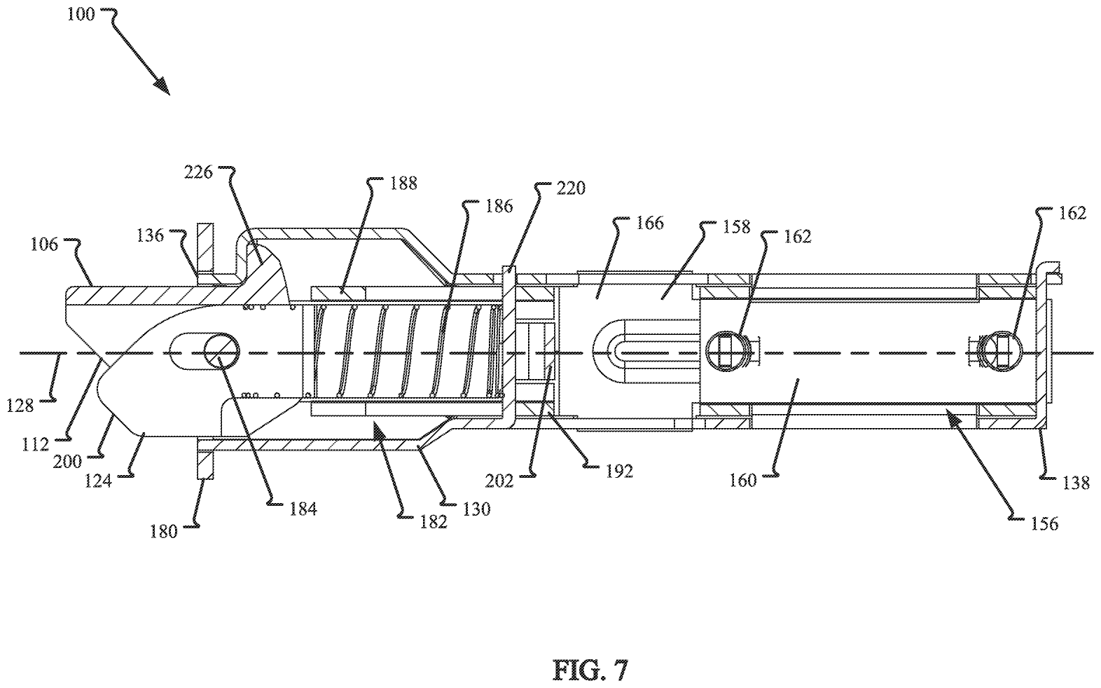

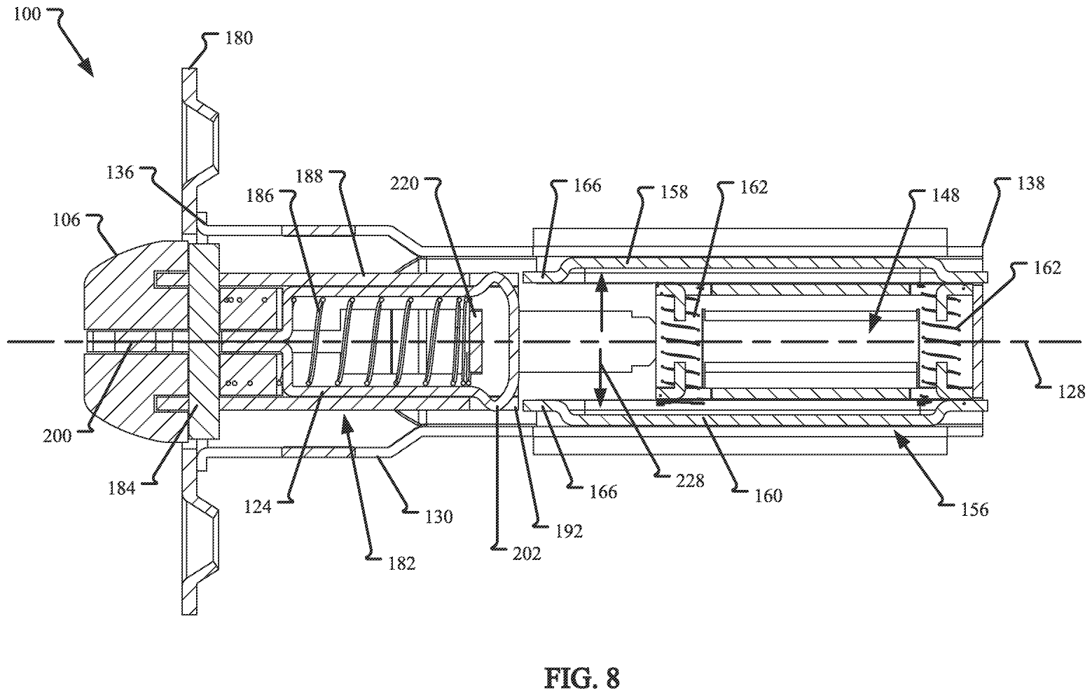

FIGS. 5 and 6 are perspective views of the extension assembly 182 for the bolt 106. The extension assembly 182 is configured to facilitate the bolt 106 moving between the extended position and the retracted position. The extension assembly 182 enables the movement of the bolt 106 when the latch assembly 100 is unlatched via operation of the locking bar assembly 156. (shown in FIG. 4) The biasing member 186 is captured within both the interposer member 124 and the carriage 188. A first end 216 of the biasing member 186 is engaged with the transverse wall 208 of the interposer member 124. An opposite second end 218 of the biasing member 186 is engaged with a bias stop 220 extending from the housing 130 (both shown in FIGS. 7 and 8). The bias stop 220 extends through both the interposer member 124 and the carriage 188 and is fixed relative to the extension assembly 182. As such, the extension assembly 182 is biased relative to the housing 130 so as to automatically retain the bolt 106 in the extended position.

The nose 200 of the interposer member 124 extends through the bolt 106 such that at least a portion of the nose 200 projects from the oblique surface 112 of the bolt 106 and at least a portion of the nose 200 is disposed at least partially within the bolt 106. The nose 200 of the interposer member 124 projects from the bolt 106 when the bolt 106 is in its extended position. The planar surface 114 of the bolt 106 does not have the nose 200 projecting therefrom. The tail 202 of the interposer member 124 is positioned adjacent the second end 192 of the carriage 188 and at least partially within the notches 196. The tail 202 extends at least to the edge of the second end 192 of the carriage 188 so that both the tail 202 and the second end 192 of the carriage 188 can contact an axially adjacent component of the latch assembly 100 such as the locking bars 158, 160 (all shown in FIG. 3). In the example, the tail 202 includes a curved surface.

The interposer member 124 and the carriage 188 are independently slidable relative to one another along the longitudinal axis 128 (shown in FIGS. 2 and 3) when an external force 222 is acted upon the interposer member 124 because of the biasing member 186. This independent movement is at least partially defined by the elongated length of the slot 204 (shown in FIG. 4) of the interposer member 124. The interposer member 124 is also independently slidable relative to the bolt 106 along the longitudinal axis 128. Once the pivot pin 184 reaches the end of the elongated slot 204, the interposer member 124 and the carriage 188/bolt 106 can slide together along the longitudinal axis 128 so as to allow the bolt 106 to move towards the extended and retracted positions because of the biasing member 186.

In the example, the external force 222 that slides the interposer member 124 inward along the longitudinal axis 128 independently from the bolt 106 and carriage 188 can be generated by the nose 200 contacting the strike plate 108 when the door 102 (both shown in FIG. 1) is being closed. This is because the interposer member 124 contacts the strike plate 108 prior to the bolt 106 when the door 102 is being closed. Additionally, the external force 222 that slides the interposer member 124 inward along the longitudinal axis 128 with the bolt 106 and the carriage 188 can be generated by the bolt 106 pivoting 224 around the pivot pin 184 and contacting the nose 200. The pivoting movement of the bolt 106 is generated by the door 102 being opened and the planar surface 114 contacting the strike plate 108. These two external forces 222 occur independently from one another.

The bolt 106 includes a fin 226 that extends from the planar surface 114. The fin 226 is configured to selectively engage with the housing 130. Additionally, the bolt 106 includes a curved surface 227 disposed between the fin 226 and the oblique surface 112. The curved surface 227 is positioned directly adjacent to the transverse wall 208 opposite of the biasing member 186.

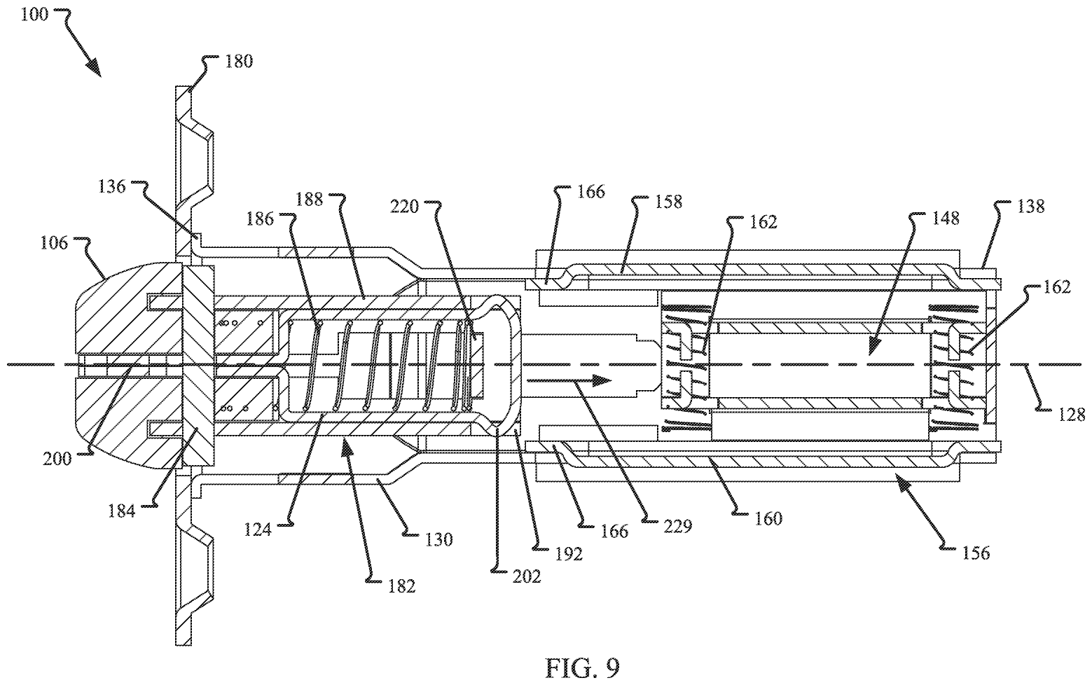

FIGS. 7 and 8 are longitudinal cross-sectional views of the latch assembly 100. Referring concurrently to FIGS. 7 and 8, the latch assembly 100 is in its biased configuration with the bolt 106 in an extended position relative to the first end 136 of the housing 130 and the locking bar assembly 156 in a blocking position. This configuration retains the bolt 106 in the extended position unless the latch assembly 100 is unlatched by moving the locking bar assembly 156 towards an unblocked position which is described below in reference to FIG. 9. As such, when the door is closed, the bolt 106 extends and can be retained within the strike plate. When the locking bar assembly 156 is in the blocking position, the extension arm 166 of each of the first and second locking bars 158, 160 is biased via the biasing members 162 (e.g., extension springs) so as to axially align with the second end 192 of the carriage 188. This position of the carriage 188 and the locking bars 158, 160 restricts the extension assembly 182 from axially moving towards the second end 138 of the housing 130 and allowing the bolt 106 to move towards a retracted position.

In the biased configuration, the biasing member 186 (e.g., a compression spring) urges the carriage 188, the interposer member 124, and the bolt 106 towards the first end 136 of the housing 130 thereby extending the bolt 106. The nose 200 of the interposer member 124 projects from the oblique surface 112 of the bolt 106 and may be offset from the longitudinal axis 128 in one direction and as illustrated in FIG. 7. The nose 200, however, does not axially project past the tip of the bolt 106 when in the extended position. The tail 202 of interposer member 124 is axially aligned with the second end 192 of the carriage 188 and within the notches.

In operation, the torque blade is configured to extend through the openings 148 of the housing 130 and engage with the locking bar assembly 156. The openings 148 and the locking bar assembly 156 are elongated along the longitudinal axis 128 so that more than one backset position of the torque blade is enabled and without any modification of the latch assembly 100. Upon rotation of the torque blade, the locking bar assembly 156 moves towards an unblocked position which allows longitudinal movement of the extension assembly 182 and the movement of the bolt 106 towards a retracted position. In the example, the first and second locking bars 158, 160 are transversely moveable 228 relative to the longitudinal axis 128 to move out of the blocking position and towards the unblocked position. In the example, the first and second locking bars 158, 160 are configured to move away from the longitudinal axis 128 to move out of the blocking position.

FIG. 9 is another longitudinal cross-sectional view of the latch assembly 100 and with the locking bar assembly 156 in an unblocked position. Certain components are described above and are not necessarily described further. Moving the locking bar assembly 156 towards the unblocked position may be performed by rotating the torque blade within the locking bar assembly 156 and moving the locking bars 158, 160 away from each other. The movement of the locking bars 158, 160 towards the unblocked position is independent from the extension assembly 182 of the bolt 106 and the bolt 106 is retained in the extended position. As such, the locking bar assembly 156 does not directly drive corresponding movement of the bolt 106. Rather, the locking bar assembly 156 being in the unblocked position merely allows the bolt 106 to freely move towards a retracted position by facilitating the extension assembly 182 to slide 229 along the longitudinal axis 128.

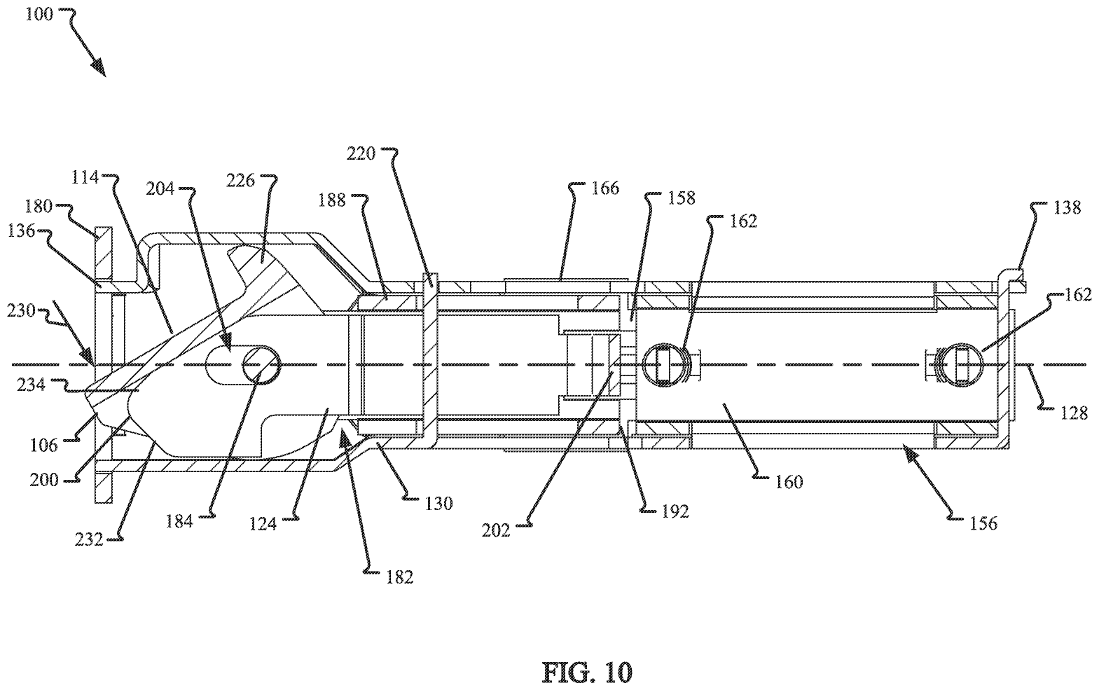

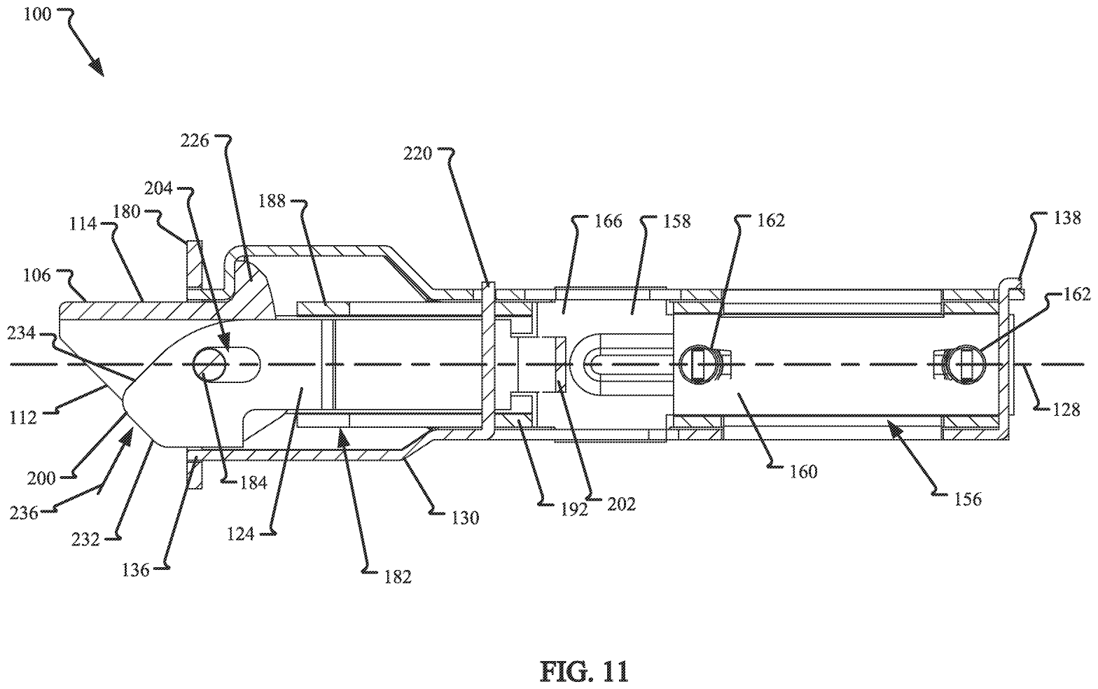

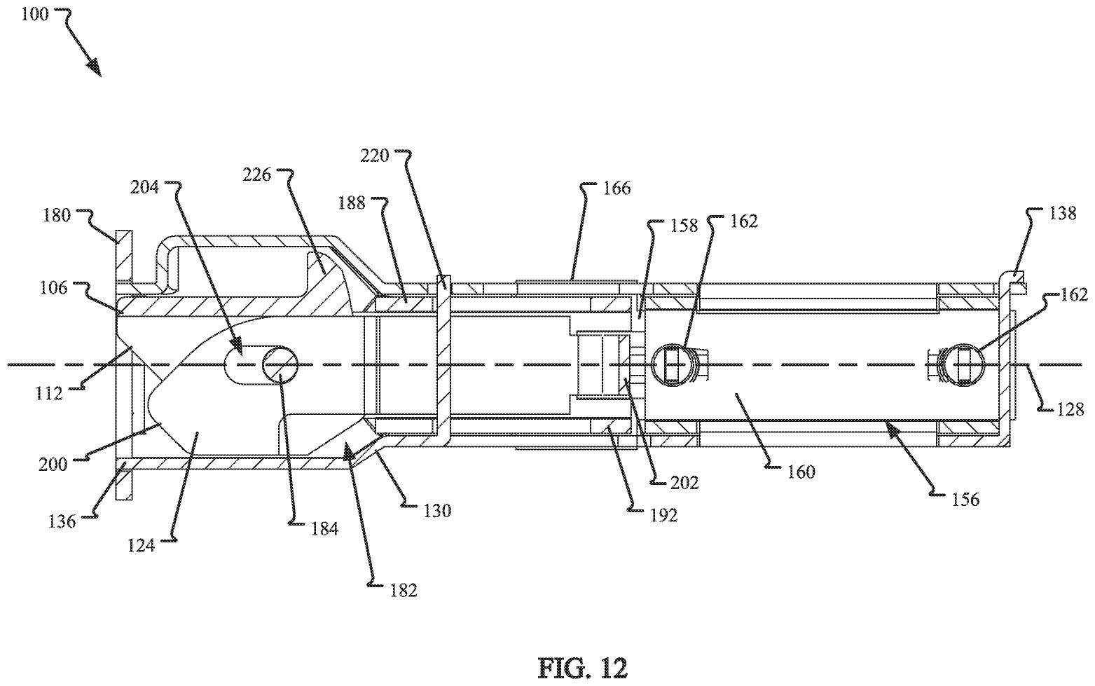

In the example, when a door is closed and the bolt 106 is extended, a handle rotates the torque blade to actuate the locking bar assembly 156. Once the locking bar assembly 156 is in its unblocked position, the door can swing open by contacting the planar surface 114 of the bolt 106 against the strike plate and generating an external force that causes the bolt 106 to move towards the retracted position as described below in reference to FIG. 10. Additionally, the interposer member 124 is able to independently move the locking bar assembly 156 towards the unblocked position and without use of the torque blade as described below in reference to FIGS. 11 and 12.

FIG. 10 is another longitudinal cross-sectional view of the latch assembly shown 100 and with the bolt 106 in the retracted position. The biasing member 186 of the extension assembly 182 is not illustrated for clarity. Additionally, the bolt 106 is in a first retracted position that is generated by an external force 230 acting on the planar surface 114 of the bolt 106 as in the case whereas the door is opening and the planar surface 114 contacts the strike plate for bolt movement. The external force 230 causes the bolt 106 to pivot around the pivot pin 184. Concurrently, the external force 230 also axially slides the bolt 106 into the first end 136 of the housing 130 to reach the first retracted position.

The axial movement of the bolt 106 is facilitated with the fin 226 rotating within the first end 136 of the housing 130 and the bolt 106 rotating relative to the nose 200 of the interposer member 124. Because the locking bar assembly 156 is in the unblocked position and the locking bars 158, 160 do not axially block the second end 192 of the carriage 188, the carriage 188 and the interposer member 124 are allowed to axially slide towards the second end 138 of the housing 130. The carriage 188 and the interposer member 124 slide together in this configuration and the tail 202 is positioned within the second end 192 of the carriage 188. The first retracted position of the bolt 106 allows the bolt 106 to clear the strike plate and the door to swing open. In the example, the bolt 106 may fully retract into the first end 136 of the housing 130. In other examples, the bolt 106 may substantially retract into the first end 136 of the housing 130 with a tip of the bolt 106 still projecting from the face plate 180.

The nose 200 of the interposer member 124 has a pair of oblique surfaces 232, 234, with the surface 234 facilitating the pivoting movement of the bolt 106 as described above. In the example, the pivot pin 184 may also slide within the elongated slot 204 of the interposer member 124.

Once the door is opened, the latch assembly 100 is configured to automatically return, via the biasing members 162, 186 to the biased configuration shown in FIGS. 7 and 8. That is, the bolt 106 automatically returns to the extended position when the external force 230 is removed and the locking bar assembly 156 automatically returns to the blocked position so as to maintain the extended position of the bolt 106. The external force 230 is not the only force that is applied to the latch assembly 100 so as to move the bolt 106 to the retracted position. Rather, when the door is opened and swings closed, an external force 236 (shown in FIGS. 11 and 12) is applied to the oblique surface 112 of the bolt 106 so as to retract the bolt 106 and allow the bolt 106 to slide across the strike plate and return to the extended position within the strike plate. However, when the door swings closed, the door user may not engage the door handle so as to position the locking bar assembly 156 in the unblocked position. In the example, the interposer member 124 is used to move the locking bar assembly 156 towards the unblocked position and allow the bolt 106 to move to the retracted position.

Referring back to FIGS. 7 and 9, the interposer member 124 is in a disengaged position relative to the locking bar assembly 156. In the disengaged position, the tail 202 of the interposer member 124 is disposed within the second end 192 of the carriage 188 and retraction of the bolt 106 is blocked by the locking bars 158, 160. Additionally, the nose 200 of the interposer member 124 extends from the oblique surface 112 of the bolt 106 so as to contact the strike plate prior to the bolt 106 when the door is swinging closed. The biasing members 186 biases the interposer member 124 towards the disengaged position.

Turning now to FIG. 11, FIG. 11 is another longitudinal cross-sectional view of the latch assembly 100 and with the interposer member 124 in an engaged position. Again, the biasing member 186 of the extension assembly 182 is not illustrated for clarity. The interposer member 124 axially slides along the longitudinal axis 128 between the engaged position and the disengaged position relative to the locking bar assembly 156. An external force 236 from the nose 200 of the interposer member 124 contacting the strike plate moves the interposer member 124 independently within the extension assembly 182 and towards the engaged position. In the engaged position, the tail 202 of the interposer member 124 moves the locking bars 158, 160 towards the unblocked position and is axially offset from the second end 192 of the carriage 188. In the example, the curved surfaces of the tail 202 engage the extension arm 166 and push the locking bars 158, 160 outwards. Once the locking bars 158, 160 are axially clear of the carriage 188, the bolt 106 is allowed to move towards the retracted position upon the external force 236 further acting on the interposer member 124 and/or the bolt 106.

In the example, the axial distance that the interposer member 124 moves between the engaged position and the disengaged position is defined by the elongated slot 204. Once the pivot pin 184 reaches the end of the elongated slot 204, the external force 236 axially slides the bolt 106 and the carriage 188 in addition to the interposer member 124 and overcoming the biasing force. The carriage 188 is able to slide because the locking bar assembly 156 is in the unblocked position via the tail 202 of the interposer member 124. When the interposer member 124 is in the engaged position, the bolt 106 is allowed to retract relative to the first end 136 of the housing 130.

The oblique surface 232 of the nose 200 may be at the same or similar angle to that of the oblique surface 112 of the bolt 106. As such, once the interposer member 124 is in the engaged position, the external force 236 can act on one or both of the interposer member 124 and the bolt 106 to further longitudinally slide the bolt 106. In the engaged position, the tail 202 of the interposer member 124 axially projects from the second end 192 of the carriage 188 and the nose 200 axially projects from the first end 136 of the housing 130. When the external force 236 acts on the oblique surface 112 of the bolt 106, the bolt 106 does not rotate around the pivot pin 184 because of the first end 136 of the housing 130. Rather, the structure of the latch assembly 100 only allows for the bolt 106 to linearly slide along the longitudinal axis 128 once the interposer member 124 moves the locking bar assembly 156.

FIG. 12 is another longitudinal cross-sectional view of the latch assembly 100 and with the bolt 106 in another retracted position. The biasing member 186 of the extension assembly 182 is not illustrated for clarity. Additionally, the bolt 106 is in a second retracted position that is generated by the external force 236 (shown in FIG. 11) acting on the oblique surface 112 of the bolt 106 as in the case whereas the door is closing and the oblique surface 112 contacts the strike plate for bolt movement. The external force 236 causes the bolt 106 to slide along the longitudinal axis 128 once the locking bar assembly 156 is unblocked and without rotation to reach the second retracted position.

Once the external force 236 moves from the interposer member 124 to the bolt 106, the interposer member 124 is urged back towards the disengaged position via the biasing member 186. However, the extension assembly 182 is axially displaced with the second end 192 of the carriage 188 between the extension arm 166 of the locking bars 158, 160 so that the locking bar assembly 156 is maintained in the unblocked position and the bolt 106 is allowed to continue to move towards the second retracted position.

The second retracted position of the bolt 106 allows the bolt 106 to clear the strike plate and the door to swing close. In the example, the bolt 106 may fully retract into the first end 136 of the housing 130. In other examples, the bolt 106 may substantially retract into the first end 136 of the housing 130 with a tip of the bolt 106 still projecting from the face plate 180. The retracted position of the tip of the bolt 106 may be the same in both the first retracted position (shown in FIG. 12) and the second retracted position or they may be different. Once the door is closed, the latch assembly 100 is configured to automatically return, via the biasing members 162, 186 to the biased configuration shown in FIGS. 7 and 8. That is, the bolt 106 automatically returns to the extended position when the external force 236 is removed and the locking bar assembly 156 automatically returns to the blocked position so as to maintain the extended position of the bolt 106.

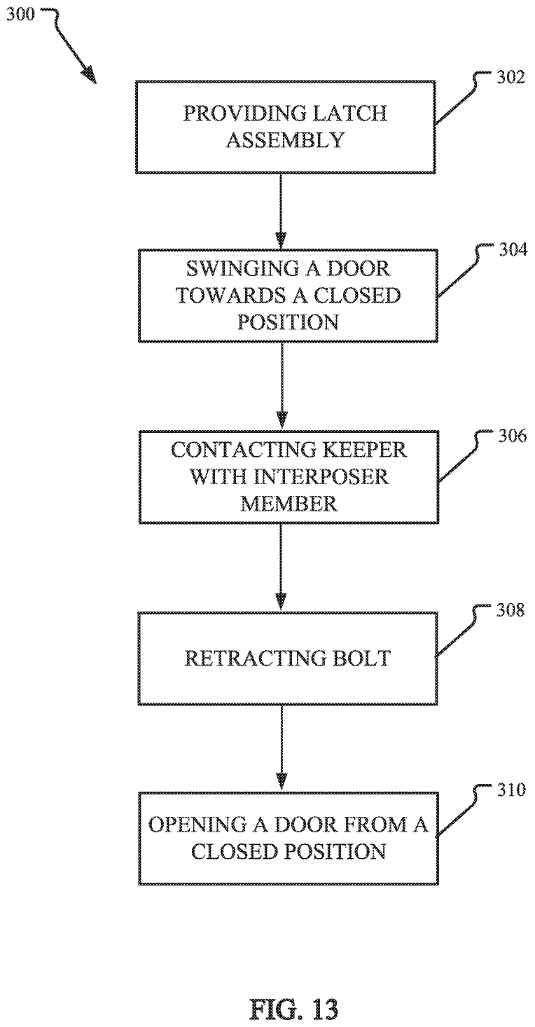

FIG. 13 illustrates a flowchart depicting a method 300 of operating a latch assembly installed on a door. The examples methods and operations can be implemented or performed by the assemblies described herein (e.g., the latch assembly 100 shown in FIGS. 1-12). The method 300 begins with providing a latch assembly installed on a door (operation 302). In the example, the latch assembly includes a housing having a first end and a second end defining a longitudinal axis. At least one locking bar is disposed proximate the second end of the housing and transversely moveable relative to the longitudinal axis. A bolt is mounted at the first end of the housing and selectively moveable relative to the first end of the housing. A carriage having a first end and an opposite second end is disposed within the housing and selectively slidable along the longitudinal axis. The bolt is pivotably coupled to the first end of the carriage and the second end of the carriage is disposed proximate the at least one locking bar. Additionally, an interposer member is included and is independent slidable along the longitudinal axis relative to the carriage.

From an open position, the door swings towards a strike plate in order to close the door (operation 304). When the door is in the open position, the latch assembly is automatically biased so that the bolt and at least a portion of the interposer member extend from the first end of the housing. As the door swings, the interposer member that extends from the first end of the housing contacts the strike plate (operation 306). Upon contact, the interposer member slides towards the second end of the housing and engages the at least one locking bar in order to move the at least one locking bar out of an axial path of the second end of the carriage. Once the at least one locking bar is moved out of the axial path of the second end of the carriage, the bolt retracts relative to the first end of the housing (operation 308).

In the example, when the interposer member slides towards the second end of the housing via contact with the strike plate, the interposer member slides independently from the carriage and the bolt. The interposer member may contact the strike plate prior to the bolt when the door swings towards the closed position. The method 300 may further include opening the door from a closed position (operation 310) such that the bolt contacts the strike plate and pivots relative to the interposer member causing the interposer member to slide along the longitudinal axis.

The latch assembly described herein facilitates a bolt configured to engage with a strike plate so as to move the bolt to a retracted position. The bolt is coupled to an extension assembly that is configured to automatically move the bolt to an extended position. A locking bar assembly selectively engages with the extension assembly in order to prevent the bolt from being retracted. When a door that the latch assembly is mounted on is to be opened from a closed position, a handle is used to move the locking bar assembly towards an unblocked position so as to enable the bolt to both pivot and slide towards a retracted position and allow the door to open. The bolt is configured to pivot around an interposer member and the interposer member need not be independently actuated.

In contrast, when the door is to be closed from an open position, the interposer member contacts the strike plate prior to the bolt. The interposer member independently slides in order to move the locking bar assembly to the unblocked position. Once the locking bar assembly is unblocked, the bolt can linearly slide towards a retracted position and allow the door to close and without use of the handle to actuate the locking bar assembly. Whenever the handle or the interposer member are released, the bolt is automatically biased towards the extended position and latched with the locking bar assembly in a blocking position.

Using the interposer element facilitates the bolt being fully biased to always be moved toward the extended position. The extended position of the bolt occurs after the latch assembly moves past the strike plate in both the opening and closing motions. This configuration increases performance of the bolt in operation of the latch assembly. There is no intermediate position that the bolt can get stuck in or undesirably move out of during operation of the latch assembly.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

Throughout this description, references to orientation (e.g., front (ward), rear (ward), top, bottom, back, right, left, upper, lower, etc.) of the components of the latch assembly relate to their position when installed on a door and are used for case of description and illustration only. No restriction is intended by use of the terms regardless of how the components of the latch assembly are situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed:

1. A latch assembly comprising:
a housing having a first end and an opposite second end defining a longitudinal axis;
at least one locking bar disposed proximate the second end of the housing, the at least one locking bar transversely moveable relative to the longitudinal axis;
a bolt mounted at the first end of the housing, the bolt selectively moveable relative to the first end of the housing;
a carriage disposed within the housing and slidable along the longitudinal axis, the carriage having a first end and an opposite second end, the bolt pivotably coupled to the first end of the carriage and the second end of the carriage disposed proximate the at least one locking bar; and
an interposer member independently slidable along the longitudinal axis relative to the carriage, wherein upon sliding the interposer member towards the second end of the housing, the interposer member engages the at least one locking bar and moves the at least one locking bar out of an axial path of the second end of the carriage, thereby allowing the bolt to retract relative to the first end of the housing.

2. The latch assembly of claim 1, wherein the interposer member is biased along the longitudinal axis such that at least a portion of the interposer member projects adjacent the bolt.

3. The latch assembly of claim 2, further comprising an axial biasing member, the axial biasing member directly engaged with the interposer member.

4. The latch assembly of claim 1, wherein the interposer member is disposed at least partially within the bolt.

5. The latch assembly of claim 1, wherein the interposer member includes a nose and a tail, the nose having at least one oblique surface.

6. The latch assembly of claim 5, wherein the second end of the carriage defines at least one notch, at least a portion of the tail received within the at least one notch.

7. The latch assembly of claim 5, wherein the tail includes at least one curved surface.

8. A latch assembly comprising:
a housing having a first end and an opposite second end defining a longitudinal axis;
at least one locking bar disposed proximate the second end of the housing, the at least one locking bar transversely moveable relative to the longitudinal axis between at least a blocking position and an unblocked position;
a bolt mounted at the first end of the housing, the bolt selectively moveable between at least an extended position and a retracted position relative to the first end of the housing;
a carriage disposed within the housing and slidable along the longitudinal axis, the carriage having a first end and an opposite second end, the bolt pivotably coupled to the first end of the carriage, wherein when the at least one locking bar is in the blocking position, the at least one locking bar is positioned in an axial path of the second end of the carriage, thereby restricting the bolt from moving from the extended position towards the retracted position; and
an interposer member movable between at least an engaged position and a disengaged position relative to the at least one locking bar along the longitudinal axis, wherein upon moving the interposer member towards the engaged position, the interposer member engages and moves the at least one locking bar towards the unblocked position, thereby removing the at least one locking bar from the axial path of the second end of the carriage and allowing the bolt to move towards the retracted position.

9. The latch assembly of claim 8, further comprising an axial biasing member biasing the interposer member towards the disengaged position.

10. The latch assembly of claim 9, wherein the axial biasing member directly engages with the interposer member.

11. The latch assembly of claim 8, wherein the interposer member is at least partially disposed within the carriage.

12. The latch assembly of claim 8, wherein the interposer member includes a nose and a tail extending along the longitudinal axis, the tail configured to engage with the at least one locking bar in the engaged position.

13. The latch assembly of claim 12, wherein the nose at least partially projects from the bolt when the bolt is in the extended position.

14. The latch assembly of claim 13, wherein the bolt includes an oblique surface, the nose disposed at the oblique surface.

15. The latch assembly of claim 8, wherein the interposer member is independently slidable relative to both the carriage and the bolt.

16. The latch assembly of claim 8, wherein the bolt is pivotable relative to the interposer member.

17. A method of operating a latch assembly installed on a door, the method comprising:
providing a latch assembly installed on a door, the latch assembly including a housing having a first end and an opposite second end defining a longitudinal axis, at least one locking bar disposed proximate the second end of the housing, the at least one locking bar transversely moveable relative to the longitudinal axis, a bolt mounted at the first end of the housing, the bolt selectively moveable relative to the first end of the housing, a carriage disposed within the housing and slidable along the longitudinal axis, the carriage having a first end and an opposite second end, the bolt pivotably coupled to the first end of the carriage and the second end of the carriage is disposed proximate the at least one locking bar, and an interposer member independently slidable along the longitudinal axis relative to the carriage;
from an open position, swinging the door towards a strike plate to close the door, wherein when the door is in the open position, the latch assembly is automatically biased so that the bolt and at least a portion of the interposer member extend from the first end of the housing;
contacting the strike plate with the interposer member extending from the first end of the housing such that the interposer member slides towards the second end of the housing and engages the at least one locking bar to move the at least one locking bar out of an axial path of the second end of the carriage; and
upon moving the at least one locking bar out of the axial path of the second of the carriage, retracting the bolt relative to the first end of the housing.

18. The method of claim 17, wherein when the interposer member slides towards the second end of the housing via contact with the strike plate, the interposer member slides independently from the carriage and the bolt.

19. The method of claim 17, further comprising opening the door from a closed position, wherein the bolt contacts the strike plate and pivots relative to the interposer member causing the interposer member to slide along the longitudinal axis.

20. The method of claim 17, wherein when the door swings towards the strike plate, the interposer member contacts the strike plate prior to the bolt.
